(19) United States
(12) Patent Application Publication
(10) Pub. No.: US 2020/0380836 A1
(43) Pub. Date: Dec. 3, 2020

(54) All-in-One Gas, Carbon Monoxide and Smoke Detector

(71) Applicant: Michael O. Harrison, Cambria Heights, NY (US)

(72) Inventor: Michael O. Harrison, Cambria Heights, NY (US)

(21) Appl. No.: 16/886,339

(22) Filed: May 28, 2020

Related U.S. Application Data
(60) Provisional application No. 62/853,718, filed on May 29, 2019.

(51) Int. Cl. G08B 17/117; G08B 21/14; H04L 29/06; H04W 76/50

(52) U.S. Cl. CPC G08B 17/117; H04W 76/50; H04L 69/16; G08B 21/14

(57) ABSTRACT

The present invention provides for a combination of sensors that disposed within a single portable unit. Such sensors may include sensors monitoring carbon monoxide levels, natural gas levels and levels of smoke emitted from a combustion event. The portable unit is connected to a first responder who is capable of responding and resolving a situation that has given rise to the anomalous reading. Such first responders may be a fire department, law enforcement, utility company squads the user/owner of the device, or his or her loved ones and/or designated individuals or companies.

### CLAIM OF PRIORITY

This application claims the priority of the U.S. Provisional Patent Application No. 62/853,718 filed on May 29, 2019, the contents of which are fully incorporated herein by reference.

### FIELD OF THE INVENTION

The present invention relates to managed hazard detectors having central monitoring and notification to interested parties.

### BACKGROUND OF THE INVENTION

A modern home is full of hazards. Electricity causes fires and poses risk of electrocution. Natural and propane gas delivery threatens inhabitants with asphyxiation or incineration in an event of a leak. Privacy and security enhancements that humans cherish, such as doors, locks, hermitizing and soundproofing, also pose additional risks of hindering detection of a dangerous condition until it is too late. Even if a detection does occur, our homes hinder outsiders from providing timely help.

Over the years, building authorities, the justice system and the marketplace, have begun setting certain safety standards and expectations. Extensive safety mechanisms have now been put into place to mitigate certain risks. For example, wiring must now be fully insulated. Electrical appliances come with a range of shutoff and power disruption features, designed to cut current in an event of a distress. The burners on stoves now come with lighters, first as a convenience, but also as a safety feature, to ignite and burn-off propane gas in an even of an accidental discharge. Natural gas, which is naturally colorless and odorless, is deliberately scented with a district pungent smell of rotten eggs to alert people of a gas leak. Building and fire code require that certain installation and safety standards be followed, such as the presence of smoke detectors.

With all these improvements, destructive incidents and disasters are still commonplace. One of the more ruinous catastrophes are explosions brought about by gas leaks. Often, occupants of spaces where such explosions occurred, had knowledge of an ongoing minor gas leak for some time and had chosen to ignore it. People are often lulled into complacency out of habit or by the fact that most minor gas leaks dissipate quickly. Most accidents occurred because the leak had grown worse over time, or because a previous ventilation opportunity had been blocked, or some combination of the two.

Most residential and commercial hazard detection solutions that exist today are smoke detectors or carbon monoxide detectors. Propane gas detectors are known in the art, but are not used in residential safety mechanisms, in part, because obtaining yet another detector is financially and logistically burdensome and because unlike smoke from a fire, propane requires a certain concentration to become volatile Most common smoke detectors that exist in the art lack sophistication to identify when a dangerous concentration level is reached.

### SUMMARY OF THE INVENTION

The device disclosed in this application is an apparatus, or a combination of apparatuses, that enable one sensor or a system of sensors to act in concert and detect dangerous concentrations of natural and/or propane gas, carbon monoxide, smoke or any other toxin being monitored. The sensors would be housed within the same portable physical device. The device is capable of accessing a local network of computers or wirelessly accessing internet or a cellular network. The network is then used for communication among sensors and to report readings to occupants or to monitoring and response centers.

Besides detecting the presence of a dangerous substance, the disclosed sensor is measuring and tracking concentration of substances with different reporting rules in place depending on the level of detection. For example, a low-level detection measured in parts per million, may result in monitoring only. A higher, or rising reading, may trigger a call to the occupant of the space, and still higher or rapidly rising reading may result in a report to first responders, such as a utility company or even the fire brigade.

A user registers a mobile device number and email address when installing the disclosed device. This contact information is used to communicate, or alert said user of dangerous or potentially dangerous situations. The user may observe various readings either directly on a liquid crystal display on the device or by accessing the device controller remotely. Similarly, the user may control the device directly on the master device or using their mobile devices, by remotely configuring response levels. The user may also configure an ability to override or escalate readings.

Additional benefits of the disclosed device are provided below:

The disclosed censor device will have the ability to give the customer a digital display of carbon monoxide, levels, smoke caused by fire, and natural gas/propane levels inside their dwelling. The disclosed device may be adopted for use both indoors and outdoors.

The disclosed device can be programmed to send a notification directly to homeowners through their smartphone device and smart watch device. The physical alarm device will have clearly labeled buttons to contact the required emergency responder, utility provider or a contact party, with a push of a button right from the physical box itself. A mobile application provided in conjunction with the physical sensor device replicates these push button features on the mobile device.

The disclosed device has the ability to connect the homeowner directly to their local gas emergency utility and 911 emergency response team if the client chooses. All possible because each device will have a wireless network connection and capability to access a cellular network which will be accessible from the main device and the software mobile application.

In the absence of an internet connection, the disclosed device will work through a 5g cellular capability and is capable of distinguishing between subscription-based and non-subscription-based service. With a monthly or yearly subscription, the disclosed sensor devices will monitor distinct hazard levels and notify the homeowner that there has been a hazard detection. Based on the level identified, the sensor will notify the customer and give the option to either contact 911 emergency response and/or have the local utility dispatched to the premise.

If the disclose sensor detection reaches a level corresponding to a certain predetermined metric, the utility company and/or fire department will be notified and dispatched. Alternatively, or concomitantly, a contact/command center may monitor the disclosed centers and then either inform the customer via phone and text that the local utility and 911 emergency response have been dispatched to the premise or initially request confirmation from the customer before summoning help.

The disclosed devices are further capable of monitoring its own health. With such sensors will sending alerts to main display and mobile device when a battery needs replacement, or if another malfunction is detected, such as inability to connect to a network.

The disclosed sensor devices can send notifications to a variety of mobile devices, such as mobile computer and SmartWatches®. Accessibility will depend on the carrier and manufacturer of the smart watch.

The disclosed system contains a digital display provides readings of either natural gas/propane, carbon monoxide, and levels of smoke caused by fire.

The disclosed device contains an amplified audio capability and Sound Alarm notifications from the main display and smart devices if a reported hazard is not acknowledged by the customer after 120 seconds has elapsed.

The disclosed device will provide constant status updates on the main display to let the owner know that their home is safe or unsafe.

Preferably the system of sensors must connect to the power grid of the home. However, each sensor is equipped with standby battery power. Alternatively, each device will be independently powered by an on-board power source such as a discharging battery or a solar rechargeable battery

### BRIEF DESCRIPTION OF THE DRAWINGS

FIG. 1 is a basic demonstration of the disclosed monitoring system.

FIG. 2 is a detailed breakdown of the contents of a sensor device.

FIG. 3 is a contextual diagram of the various components of the disclosed monitoring system.

FIGS. 3A-3C demonstrate various topological alternatives supported by the disclosed devices and methodologies.

FIG. 4 demonstrates the novel reporting layout supported by the monitoring and alerting system.

FIGS. 5 & 6 provide a high-level illustration of the method enabled by the disclosed devices.

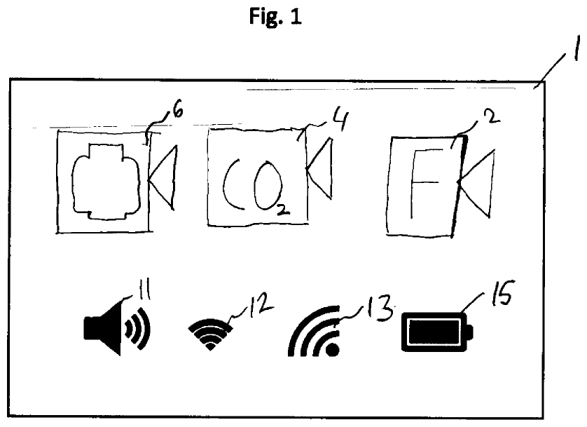

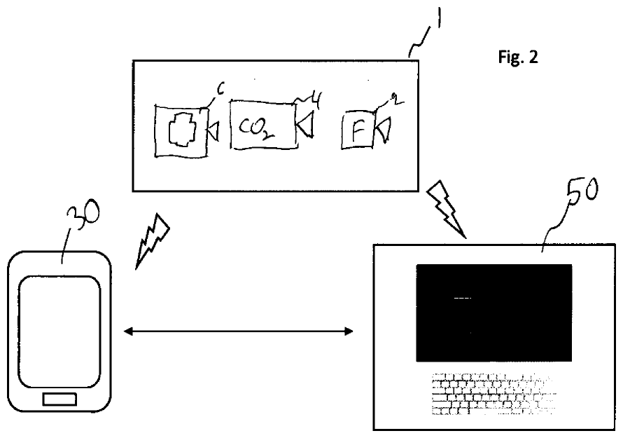

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The sensor device 1 contains a combination of at least three integrated sensors, comprised of a smoke detector 2, the carbon monoxide detector 4 and a natural gas or propane detector 6. Additional or differing combination of detection devices is possible, such as a pollen sensor, or radiation or pollution sensors. The idea behind a combination sensor device 1 is to provide a comprehensive monitoring snapshot of all areas that may potentially lead to a situation that is hazardous to heath and safety of occupants of a structure. In residential areas, a leak of natural gas represents one of the biggest safety hazards since a leak may lead to an explosion, which will likely cause property damage, injury or even death. The natural gas sensor 6 is designed to not only monitor the concentration of gas per volume of air, but to also detect the fluctuation of this concentration. Thus, a moderate reading may belie an ominous pattern that a tracking capable sensor is able to detect. The device 1 is may store a history of sensory readings locally or a prior history may be stored on the control pad 30 or reported and stored at a call center 50.

Besides internal detection instrumentation, the device 1 will further contain communication means 12 to connect with a controller pad 10 and/or a network device 13 to access the internet. The device 1 may additionally contain a high-performance speaker 11 to issue a loud tone in an event that an abnormal level of a monitored substance is detected, and an onboard battery 15. The battery 15 may be rechargeable standby battery powered by home's circuitry. The audio-visual alert may differ depending on the substance detected. For example, a carbon monoxide, may be a high-pitched chime, a propane leak may be a clang and smoke detection may result in a siren. Alternatively, one type of chime may be emitted, followed by a voice clarifying the source of the alarm, such as “beep!!!, Alarm, gas leak! !” Preferably, the sensor will be configured to be positionally aware. For example, “beep!!!, Alarm, gas leak, kitchen! !” The responders, whether it is a fire department, a utility company, a monitoring service or just the user, would be similarly alerted with an alarm, and the location where the alarm was triggered. Similarly, the control pad 30 may also contain a communication means 12 to connect with a sensory device 1 or with a first responder or a user. The control pad 30, must also have a network device 13, and or a cellular transceiver 14. The control pad 30 may contain a high-performance speaker 11. In yet another alternative, the control pad 30 may combine the sensory capabilities of the device 1 with all capabilities of the control pad 30.

The detector device 1 may be directly connected to a user's device 20, which may be a mobile device or a computer. The reporting device 20 may be a screen, ticker or an email message that is generated on a responder's device. Preferably, a local control pad 30 is able to configure each individual detector device 1 and communicate with the reporting device 20 and responders 40 (FIG. 4). The control pad 40 preferably contains an informational screen 42 and a keypad 44. The information screen 42 preferably contains a status of sensor reading 41 and maintenance and miscellaneous outputs 43. The sensor reading 41 may be segregated by each individual detector device 1 or by zone, for example, first floor or second floor. Zones may be further subdivided, such as first floor garage, or first floor-kitchen. A control pad 40 be connected to some or all detector devices 1. The control pad 40 may also function as secondary pads with one primary pad being in a single location. Alerting will then correspond to the layout. For example, “second floor, zone one, master bedroom.” Maintenance or miscellaneous outputs may provide configuration information, health status of the devices, or promotional messages and practical guidance.

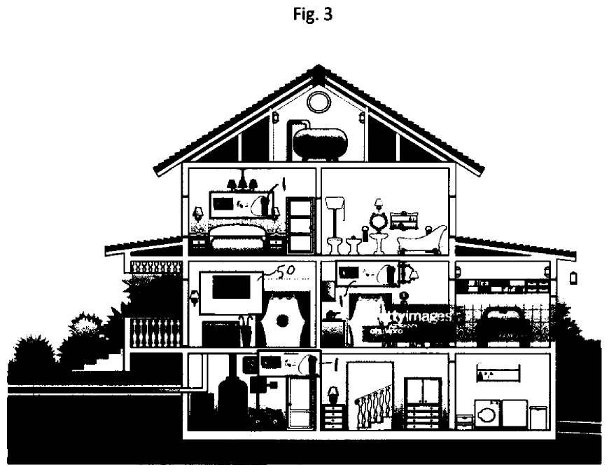

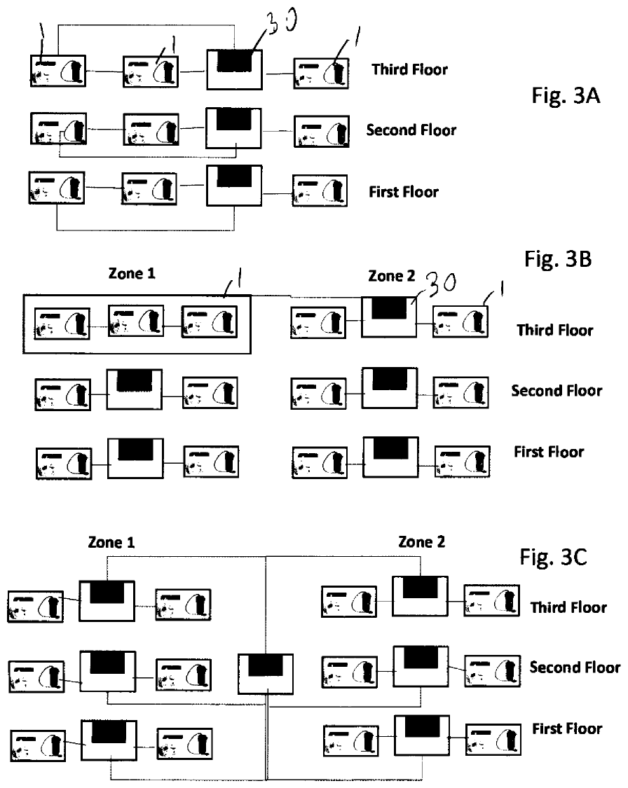

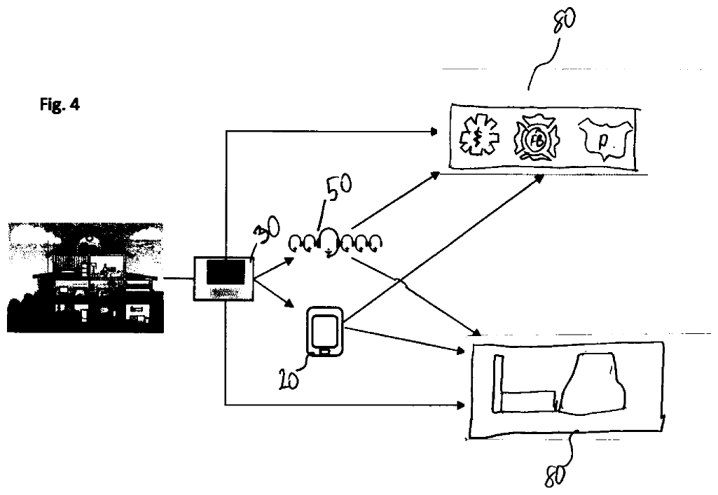

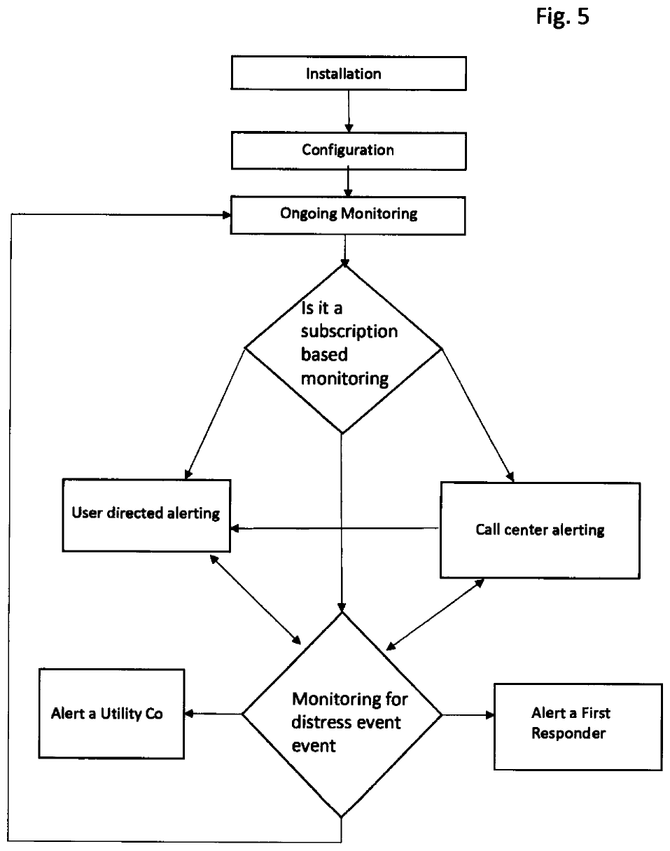

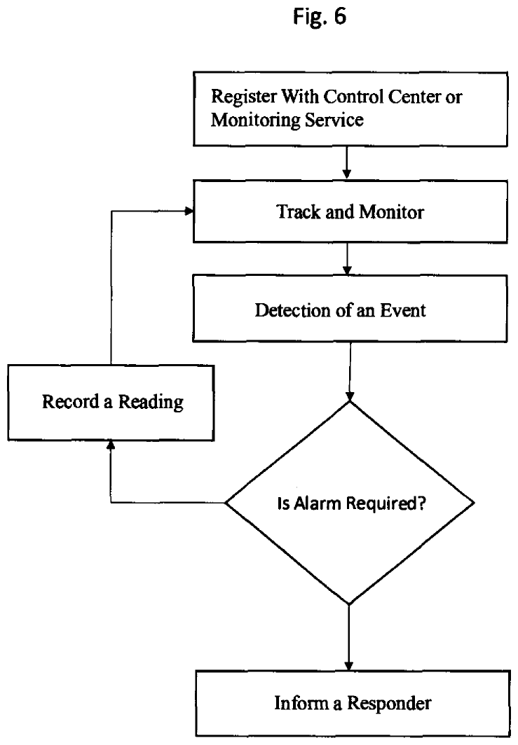

The disclosed devices are designed to be installed in strategic spots that are most suitable to early detection of toxins or near human sleeping quarters. For example, the sensor device 1 should be installed in areas where natural gas is burned off, such as boiler rooms or kitchens. Sensor device 1 or at least the speaker portion 11 of the sensor 1 should be placed near bedrooms and other quarters frequented by human habitation and used for sleeping. The diagram shown in FIG. 3 demonstrates that a control pad 30 is strategically placed in an area frequented by people during waking hours, and provides a way to control, monitor and review sensor readings produced by sensor devices 1 that are placed in areas maximizing the tactical effectiveness of the onboard censors. The sensor device 1 and the control panel 50 then uses short range wave signals or wired network connection to establish communication with each other. The control panel 50 or the devices 1 are preloaded with intelligence on what constitute a safe or unsafe concentration of a toxin being monitored.

FIGS. 3A-3C demonstrate the scalability of the devices disclosed in the current description. FIG. 3A contains the sensor devices 1 on the first flow, for example, in foyer, the kitchen and garage, where sensor devices 1 on the first floor connect to the control pad 30 on the first floor. Similarly, the sensor devices 1 on the second floor, connect to the control pad 30 on the second floor, and similarly for the third floor. Alternatively, one control pad 30 may be controlling and corresponding with all of the sensor devices 1 on all floors.

FIG. 3B demonstrates a further differentiation, by splitting a floor into zones, with each zone controlled by a separate control pad 30, or as in the case of the third floor, a single control pad 30 may control devices 1 within one, two or more zones. Separating devices 1 by zones permits an alert to be issued by a particular zone, rather than by individual device. Zoning also permits an alternating calibration of detection sensitivity. For example, a zone located near the garage will need to be slightly less sensitive to carbon monoxide, or a zone located in the kitchen may need to be slightly less sensitive to a natural gas leak, to avoid reporting a lot of false positives.

FIG. 3C demonstrates that each control pad 30 may be configured to first report to one or more central control pad 30. It should be noted that in FIGS. 3A-3C the control pads 30 may each communicate with a first responder, or a user, or the user or a first responder will be alerted by only by a control pad 30 which is managing a device 1 where an alert has been triggered. All devices shown in FIGS. 3A-3C may be controlled remotely by a user device 20 or by a call center 50 and may similarly be configured, calibrated and interrogated remotely using a user device 20, by a call center 50 or any other party having a third party access to a control pad 30 or the device 1, depending on whether such devices 1 are autonomous from a control pad 30.

In an event where an issuance of an alert is warranted, the control panel 50, or the sensor device 1, whichever it may be based on the particular embodiment utilized, informs the first responder. Based on a preconfigured setting provided by a user, or if the alert arises from a non-critical sensory reading, a user's mobile device 20 may be the first responder device. Alternatively, a call center 60 may be monitoring the panel 50, with the intention of then summoning a fire brigade 70, a visit from a local utility 80 or to merely inform a user 20 that a potential problem is present.

The detector devices 1 may be enabled using purely electrical circuitry, with interpretation taking place at the control pad 40, which would be alerted about an anomalous reading by the detector device 1. The control pad 40 is preferably a mini-computing device having electrical circuitry controlled by a processing unit that is operated by a mobile operating system. Alternatively, both the detector devices 1 and the control pad 40 may be autonomous computer devices, having a mobile operating system operating local circuitry and communication modules.

The detector devices 1 must be first installed in a strategic location and configured, providing information, such as room size, network information or cellular receiving configuration and first responder information. Where a user of the device 1 has purchased a subscription from a purveyor of the device 1, or another provider, such as the call center 50, the subscription information, if not already preconfigured, would be entered at this point. Once confirmation has been completed, monitoring begins. Depending on the alert level or response steps established at configuration, or determined by reasonable safety standards or legal code, certain alerts are sent to a user of the device, while other must be forwarded directly to a professional first responder, such as a utility company. The forwarding schematic is preferably controlled by each individual sensor device 1, by the control panel 50 or which is to some extent configurable.

At the same time, the health and each sensor must be monitored as well. As shown in FIG. 6, each device disclosed in the present application must be tracked and monitored, either using the control panel 50, or using the call center 50, or both. During this time, if an abnormal sensory reading is detected, the system must evaluate whether the reading is reasonable and not erroneous, and then quickly determine whether an alarm is required. If the alarm is not required, by the incident nevertheless requires attention, for example, if the readings are elevated, but not dangerous, or if there is a steady increase in concentration between several contiguous readings, then the reading must be recorded to a potential later alert of a responder.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A sensor device comprising at least 2 sensors, one of which is natural gas sensor; said sensor continuously sampling a surrounding airspace for at least two chemical substances that said at least two sensors are capable of detecting; said sensor device capable of detecting an anomalous reading by comparing any latest reading to a history of continuous sampling on said sensor or an against an accepted standard; a response network of connected devices wherein said sensor being one of said network of connected devices with at least one other of said connected devices being a first responder; and said sensor device using said network of connected devices to send said reading to said first responder.

2. The sensor device claim 1, wherein said network of connected devices supports communication up to and including 3^{rd} Generation Partnership Project's 5G standard or a communication using Transmission Control Protocol and Internet Protocol.

3. The sensor device of claim 1, wherein said first responder is from a group comprising an owner of said sensor device, an owner or occupant of a premises where said sensor device is located, a utility company, a fire brigade, or any combination thereof.

4. A combination of sensors comprising at least 3 sensors within a detection unit, wherein said combination alerts a first responder monitoring anomalous readings of toxins being monitored by said combination, said detection unit capable of detecting an anomalous reading by comparing any latest reading to a history of continuous sampling on said sensor or an against an accepted standard; a response network of connected devices wherein said detection unit being one of said network of connected devices with at least one other of said connected devices being a first responder; and said detection unit using said network of connected devices to send said reading to said first responder.

5. The combination of claim 4, wherein said network of connected devices supports communication up to and including 3^{rd} Generation Partnership Project's 5G standard or a communication using Transmission Control Protocol and Internet Protocol.

6. The combination of claim 4, wherein said first responder is from a group comprising an owner of said sensor device, an owner or occupant of a premises where said sensor device is located, a utility company, a fire brigade, or any combination thereof.
